(19) United States
(12) Patent Application Publication
(10) Pub. No.: US 2014/0366390 A1
(43) Pub. Date: Dec. 18, 2014

(54) Organizational Device

(71) Applicants: Justin Lampley, Sylmar, CA (US); Brandan Ansan, Chatsworth, CA (US); Corey W. White, Sylmar, CA (US)

(72) Inventors: Justin Lampley, Sylmar, CA (US); Brandan Ansan, Chatsworth, CA (US); Corey W. White, Sylmar, CA (US)

(21) Appl. No.: 13/920,940

(22) Filed: Jun. 18, 2013

(51) Int. Cl. B26B 21/40

(52) U.S. Cl. CPC B26B 21/40
USPC 30/537

(57) ABSTRACT

An organizational device includes an organization and dispensing container that facilitates the organization and accessibility of beautification tools, cords, and accessories. The device includes a housing configured to store, dispense, and segregate the tools and accessories and electrical cords that join with the tools. The device utilizes various means to organize the tools, including, without limitation, variously shaped and dimensioned containers, holsters, and slots. Additionally, color coding, magnet holders, text, and graphics help segregate the tools. A retraction portion includes reels that wind and unwind the cords from the tools for extension and retraction. Each cord passes through a cord reel and plugs into a single power outlet. A locking grommet regulates the winding and unwinding of the cords. In this manner, each tool can be identified and accessed, and each cord is stored out of view to help restrict tangling and misidentification.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to organizational devices. More particularly, the invention relates to organizational and dispensing devices for beautification tools and accessories.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that hair clippers are specialized implements used to cut human head hair. They work on the same principle as scissors, but are distinct from scissors themselves and razors.

Typically, electrical cords used outdoors, in wet areas, around oils, or exposed to sunlight for long periods are selected for specific services. An extension reel is an extension lead that rolls up, usually into the socket end, which in some cases has more than one socket on it. Another type of extension reel hangs near the plug end and permits the user to draw the cord out by grasping the socket end. Some cords contain multiple female connectors. Others have female connectors spaced along the length of the cord.

Typically, organizing is the act of rearranging elements following one or more rules. Anything is commonly considered organized when it looks like everything has a correct order or placement. Electrical cords often become tangles and require organization.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a blow up view of an exemplary organization device, in accordance with an embodiment of the present invention; and

FIG. 2 illustrates a blow up view of an exemplary beautification tool joined with an exemplary cord, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings. There are various types of organizational devices that may be provided by preferred embodiments of the present invention. In one embodiment of the present invention, an organizational device includes an organization and dispensing container that facilitates the organization and accessibility of beautification tools, cords, and accessories. The device includes a housing configured to store, dispense, and segregate the tools and accessories and electrical cords that join with the tools. The device utilizes various means to organize the tools, including, without limitation, variously shaped and dimensioned containers, holsters, and slots. Additionally, color coding, magnet holders, text, and graphics help segregate the tools. A retraction portion includes reels that wind and unwind the cords from the tools for extension and retraction of the cords. Each cord passes through a cord reel and plugs into a single power outlet. A locking grommet regulates the winding and unwinding of the cords. In this manner, each tool can be identified and accessed, and each cord is stored out of view to help restrict tangling and misidentification. In some embodiments, the organizational device may utilize various means to organize the cords and wires that extend from the beautification tools, including, without limitation, retraction/extension means, winding storage, and shorter cords. In this manner, each beautification tool may be efficiently identified and accessed, and each cord may be stored out of view to help restrict tangling and misidentification of the beautician tool. Additionally, the interchangeability of the cords within the organization device may allow an eclectic assortment of beautification tools to be utilized simultaneously. The relative simplicity of positioning each cord inside the organization device by passing the cord through a cord reel and plugging multiple cords into a single power outlet further allow for flexibility and enhanced organization.

In one embodiment, the organizational device may include at least one interchangeable cord retraction portion for helping to organize and dispense at least one cord for a tool. The tool may include, without limitation, a hair clipper, an electric razor, a hair curler, and a blower. However, in other embodiments, the tool may include, without limitation, construction tools, surgery tools, computer repair tools, and cooking tools. The cord retraction portion may be operable to at least partially enable the extension and retraction of the at least one tool by regulating the respective cord of each tool. In some embodiments, each cord may coil into a cord retraction portion, whereby each tool may be organized into a unique cord retraction potion. In yet another embodiment, each cord may interchange between each cord retraction portion, thereby allowing additional flexibility and variety for the tool. The cord may extend from one end of the cord retraction portion to join with a power outlet positioned inside the housing, whereby a cable held thereon may join with an external power source. In some embodiments, each cord retraction portion may be biased in a retracting direction. The bias therein may eliminate slack in the at least one cord. The retraction portion may include a retraction switch, which may be manipulated to at least partially release each cord, thereby allowing the tool to return to a storage area on the housing. In one alternative embodiment, the cord retraction portion may include a locking grommet between the cord and a slot in the housing that helps restrict movement forces on the cord during extension and retraction.

In one embodiment of the present invention, the housing may include an upper cover and a lower base. A cover may detachably position over the base. In some embodiments, the housing may include an angled dashboard for providing a clear view of the at least one tool and the at least one accessory. Suitable dimensions for the housing may include, without limitation, a 22″×10″×7″ rectangular configuration. The housing may further include a slightly angled dashboard positioned above the base. In one embodiment, the cover may include at least one tool container for storing and segregating each tool into a separate storage. The at least one tool container may include at least one holster configured to contain a tool, such as hair clippers. In some embodiments, the at least one tool container may include a neck tie holster. The at least one tool container may include circular indentions configured for cord placement of the hair clippers. In some embodiments, the cover may include at least one accessory container. The at least one accessory container may be configured to contain at least one accessory, including, without limitation, scissors, combs, spray cans, rags, razors, curling irons, talcum powder, and business cards. The at least one accessory container may include, without limitation, four 1½″ in deep circular indentions and one 1½″ in deep card holder.

In one embodiment of the present invention, a method for installing the at least one cord from each tool into the organization device may help minimize obstruction from the numerous cords, while also allowing for a more diverse assortment of beautification tools. For example, without limitation, a barber may select four hair clippers. The barber may then extend each cord from the respective hair clipper through a reel of at least one cord retraction portion. After passing the cords through, the barber may then plug the end of the cord into the single power outlet inside the housing. In this manner, a plurality of cords may converge towards one small area for additional organization. The cover portion of the housing may then be secured onto the base portion, and fasteners applied. The barber may then organize each hair clipper and each accessory as desired. In one embodiment, the barber may position the hair clippers in the at least one container and the neck tie box in the at least one neck tie holster. If the hair clipper does not require length during storage, the retraction switch may be manipulated to retract the cord into the cord retraction portion. The barber may then begin to accessorize the organization device with the cans, cards, scissors, combs, and razors. Finally, the barber may plug a cord from the power outlet into an external power source to power the hair clippers. In this manner, the barber may extend and retract the hair clippers during a hair cut with minimal exposure to the cords. It is also significant of note that the barber may have expedited access to the accessories due to the structured configuration of the organization device.

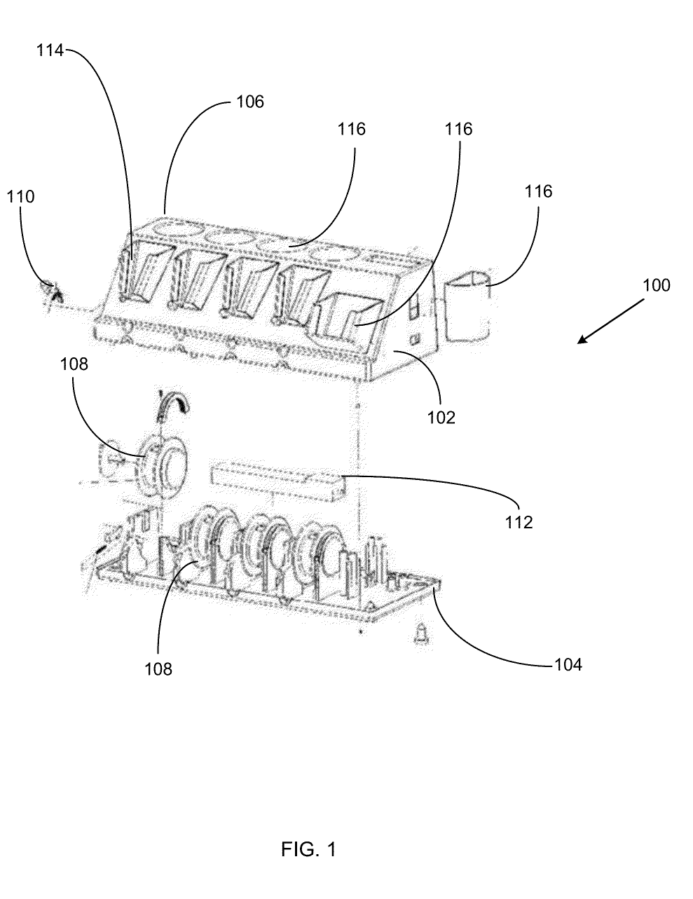

FIG. 1 illustrates a blow up view of an exemplary organization device, in accordance with an embodiment of the present invention. In the present invention, the organizational device may include an organization device 100 that helps to facilitate the organization and accessibility of beautification tools and accessories. Those skilled in the art, in light of the present teachings, will recognize that a beautician, including, without limitation, a barber, a hair stylist, and a manicurist may focus on a part of the body to provide sufficient service. The intense focus on the job may detract from the beautification tools, and may lead to accidents.

In one embodiment of the present invention, the organizational device may include a substantially rectangular housing 102 configured to store and dispense at least one tool and at least one accessory along with any electrical cords that join with the at least one tool. However, in other embodiments, the housing may include various shapes, including, without limitation, a cube, a sphere, and a pyramid. In yet another embodiment, the cover may detach, and the tools may be exposed, yet still accessible. The housing may include a cover portion 106 configured to cover the base portion, and hold the at least one tool. The organizational device may utilize various means to organize the beautification tools, including, without limitation, containers, holsters, and slots. Additionally, the at least one tool may be segregated with color coding, magnet holders, text, and graphics. Similarly, the organizational device may utilize various means to organize the cords and wires that may extend from the beautification tools, including, without limitation, retraction/extension means, winding storage, and shorter cords. In this manner, each tool may be efficiently identified and accessed, and each cord may be stored out of view to help restrict tangling and misidentification of the beautician tool. Additional features of the organizational device may include, without limitation, restricting visibility of the cords, and minimizing the number of power outlets required to operate a plurality of beatification tools. Suitable materials for the organizational device may include, without limitation, plastic, aluminum, wood, fiberglass, and high density polymers.

In one embodiment, the organizational device may include at least one interchangeable cord retraction portion 108 for helping to organize and dispense the at least one tool and the at least one cord. The at least one retraction portion may include, without limitation at least one retraction reel. The at least one tool may include, without limitation, a hair clipper, an electric razor, a hair curler, and a blower. The cord retraction portion may be operable to at least partially enable the extension and retraction of the at least one tool by regulating the respective cord of each tool. In some embodiments, each cord may coil into the cord retraction portion, whereby each tool may be organized into a unique cord retraction potion. In yet another embodiment, each cord may interchange between each cord retraction portion, thereby allowing for additional flexibility and variety of the at least one tool. In one embodiment, the cord retraction portion may provide an extension to the tool cord. The cord retraction portion may further include one or two female sockets. The at least one cord may extend from one end of the cord retraction portion to join with a power outlet 112 positioned inside the housing, whereby a cable held thereon may join with an external power source. In some embodiments, each cord retraction portion may be biased in a retracting direction. The bias therein may eliminate slack in the at least one cord. The retraction portion may include a retraction switch 110, which may be manipulated to at least partially release each cord, thereby allowing the tool to return to a storage area on the housing. The retraction switch may include, without limitation, a button, a switch, and a trigger. In one alternative embodiment, the cord retraction portion may include a locking grommet between the cord and a slot in the housing that helps restrict movement forces on the cord during extension and retraction. The retraction switch may operatively join with the locking grommet to release the cord, and thereby return the at least one tool to the respective container for storage.

In one embodiment of the present invention, the housing may include a cover and a base. The cover may detachably position over the base. In some embodiments, the housing may include an angled dashboard for providing a clear view of the at least one tool and the at least one accessory. Suitable dimensions for the housing may include, without limitation, a 22″×10″×7″ rectangular configuration. However, smaller or larger configurations may be utilized in other embodiments. The housing may further include a slightly angled dashboard positioned above the base. In one embodiment, the cover may include at least one tool container 114 for storing and segregating each tool into a separate storage. The at least one tool container may include at least one holster configured to contain the at least one tool, such as hair clippers, electrical razors, and neck tie pins. In some embodiments, the at least one tool container may include a neck tie holster. The at least one tool container may include circular indentions configured for cord placement of the hair clippers. In some embodiments, the cover may include at least one accessory container 116. The at least one accessory container may be configured to contain at least one accessory, including, without limitation, scissors, combs, spray cans, rags, razors, curling irons, talcum powder, and business cards. The at least one accessory container may be sized and dimensioned to include, without limitation, four 1½″ in deep circular indentions and one 1½″ in deep card holder.

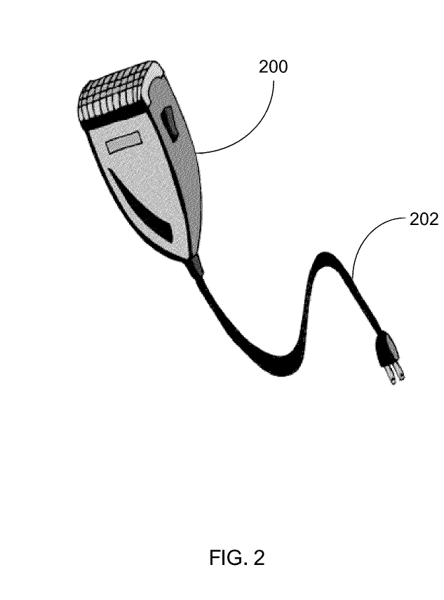

FIG. 2 illustrates a blow up view of an exemplary tool joined with an exemplary cord, in accordance with an embodiment of the present invention. In the present invention, the organizational device may organize at least one tool 200 by helping to eliminate tangling of at least one tool cord 202 that extends from the tool. The organizational device may further function to reduce visibility of the at least one cord by containing each coed inside the housing. In a further embodiment, the power outlet on the base of the organizational device may serve to reduce the amount of power outlets used at one time. Those skilled in the art, in light of the present teachings, will recognize that shearing a head with an electrical hair clipper may require repetitive extension and retraction of the cord. Tangling may compromise the quality of the cut. Thereby, organizing each hair clipper into the at least one tool container and each cord into a respective at cord retraction portion may help facilitate and expedite the hair cut.

In one alternative embodiment, each tool container, holster, and accessory container is color coded to identify different tools and accessories. In yet another alternative embodiment, each tool container, holster, and accessory container is labeled with text and/or graphics to identify different tools and accessories. In yet another alternative embodiment, the housing is segregated into two sides: one side for the tools, and the other side for the accessories. In one alternative embodiment, each cord extension that joins with the tool cord is color coded to identify the tool with the appropriate cord. In yet another alternative embodiment, the housing includes illumination to highlight empty containers and slots. In yet another alternative embodiment, the containers may be detached from the housing and replaced with differently shaped containers for allowing greater flexibility in the types of tools used. In yet another alternative embodiment, each container in the housing is operable to recharge the tool when the tool is positioned inside the appropriate container. In yet another alternative embodiment, the tools may include, construction tools, medical tools, auto repair tools, and cooking tools. In yet another alternative embodiment, the tool container positions in proximity to an accessory container such that commonly used tools and accessories are within easier reach. For example, without limitation, scissors and combs may be adjacent to each other, while eyebrow pluckers may be positioned on the side of the housing. In yet another alternative embodiment, the tool container may have a disinfecting liquid inside for sanitizing the tools while in storage.

In one embodiment of the present invention, a method for installing the at least one cord from each tool into the organization device may help minimize obstruction from the numerous cords, while also allowing for a more diverse assortment of beautification tools. For example, without limitation, a barber may select four hair clippers. The barber may then extend each cord from the respective hair clipper through a reel of at least one cord retraction portion. After passing the cords through, the barber may then plug the end of the cord into the single power outlet inside the housing. In this manner, a plurality of cords may converge towards one small area for additional organization. The cover portion of the housing may then be secured onto the base portion, and fasteners applied. The barber may then organize each hair clipper and each accessory as desired. In one embodiment, the barber may position the hair clippers in the at least one container and the neck tie box in the at least one accessory container. If the hair clipper does not require length during storage, the retraction switch may be manipulated to retract the cord into the cord retraction portion. The barber may then begin to accessorize the organization device with the cans, cards, scissors, combs, and razors. Finally, the barber may plug a cord from the power outlet into an external power source to power the hair clippers. In this manner, the barber may extend and retract the hair clippers during a hair cut with minimal exposure to the cords. It is also significant of note that the barber may have expedited access to the accessories due to the structured configuration of the organization device.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing a beautification tool organization device that stores the beatification tool, and manages the electrical cords according to the present invention will be apparent to those skilled in the art. Various aspects of the invention have been described above by way of illustration, and the specific embodiments disclosed are not intended to limit the invention to the particular forms disclosed. The particular implementation of the beautification tool organization device that stores the beatification tool, and manages the electrical cords may vary depending upon the particular context or application. By way of example, and not limitation, the beautification tool organization device that stores the beatification tool, and manages the electrical cords described in the foregoing were principally directed to cord extension reels inside a housing that also stores hair clippers and cutting accessories implementations; however, similar techniques may instead be applied to any tools that contain electrical cords, water hoses, or wires, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A device comprising:
a housing, said housing being configured to at least partially contain and segregate at least one tool, and/or at least one tool cord, and/or at least one accessory, said housing comprising a base portion, said base portion comprising a retraction portion, said retraction portion being configured to at least partially store and dispense said at least one tool cord, said retraction portion comprising at least one retraction switch, said retraction switch being operable to actuate an extension and a retraction of said at least one tool cord, said housing further comprising a cover portion, said cover portion being disposed to at least partially join with said base portion, said cover portion comprising at least one tool container, said at least one tool container being configured to at least partially store and segregate said at least one tool, said cover portion further comprising at least one accessory container, said at least one accessory container being configured to at least partially store and segregate said at least one accessory, said at least one accessory being operable to at least partially function with said at least one tool.

2. The device of claim 1, in which said at least one tool comprises a hair clipper, and/or an electric razor, and/or a hair curler, and/or a blower.

3. The device of claim 1, wherein said at least one accessory comprises a pair of scissors, and/or a comb, and/or a spray can, and/or a rag, and/or a razor, and/or a curling iron, and/or talcum powder, and/or business cards.

4. The device of claim 1, in which said at least one cord comprises a power cord.

5. The device of claim 1, wherein said at least one cord is operable to extend from said at least one tool to a power outlet through said retraction portion.

6. The device of claim 1, in which said retraction portion comprises at least one reel.

7. The device of claim 6, wherein said at least one reel is operable to wind and/or unwind said at least one cord for retracting and extending said at least one cord.

8. The device of claim 7, wherein said at least one reel is operable to be biased in a retracting direction.

9. The device of claim 1, in which said cord retraction portion comprises an extension cord.

10. The device of claim 9, wherein said extension cord is disposed to join with said at least one cord.

11. The device of claim 1, in which said cord retraction portion comprises a locking grommet.

12. The device of claim 11, wherein said locking grommet is disposed to position between said at least one cord and a slot in said housing.

13. The device of claim 12, wherein said locking grommet is operable to help restrict movement forces on said at least one cord during extension and retraction.

14. The device of claim 1, wherein said cover portion is operable to detach from said base portion.

15. The device of claim 1, in which said cover portion comprises an angled dashboard for enhancing the visibility of said at least one tool and/or at least one accessory.

16. The device of claim 1, in which said at least one tool container comprises at least one holster, said at least one holster being configured to orient said at least one tool for facilitated access.

17. The device of claim 16, in which said at least one holster comprises different shapes and/or color coding and/or slots and/or text and/or graphics for segregating between each tool.

18. The device of claim 1, in which said at least one tool container comprises a neck tie holster for retaining a neck tie.

19. A device comprising:
means for securing a cover portion onto a base portion;
means for organizing at least one tool in at least one tool container;
means for organizing at least one accessory in at least one accessory container;
means for selecting at least one tool from said at least one tool container;
means for selecting said at least one accessory from said at least one accessory container;
means for extending at least one cord through a retraction portion;
means for joining said at least one cord with a power outlet; and
means for utilizing said at least one tool and/or at least one accessory.

20. A device consisting of:
a housing, said housing being configured to at least partially contain and segregate at least one tool and/or at least one tool cord and/or at least one accessory, said at least one tool comprising a hair clipper, and/or an electric razor, and/or a hair curler, and/or a blower, said at least one accessory comprising a pair of scissors, and/or a comb, and/or a spray can, and/or a rag, and/or a razor, and/or a curling iron, and/or talcum powder, and/or business cards, said housing comprising a base portion, said base portion comprising a retraction portion, said retraction portion being configured to at least partially store and dispense said at least one tool cord, said retraction portion comprising at least one retraction switch, said retraction switch being operable to actuate an extension and a retraction of said at least one tool cord, said retraction portion comprising at least one reel, said at least one reel being operable to wind and/or unwind said at least one cord for retracting and extending said at least one cord, said at least one reel being operable to be biased in a retracting direction, said cord retraction portion further comprising a locking grommet, said locking grommet being disposed to position between said at least one cord and a slot in said housing, said locking grommet being operable to help restrict movement forces on said at least one cord during extension and retraction, said housing further comprising a cover portion, said cover portion being disposed to detachably join with said base portion, said cover portion comprising an angled dashboard for enhancing the visibility of said at least one tool and/or at least one accessory, said cover portion further comprising at least one tool container, said at least one tool container being configured to at least partially store and segregate said at least one tool, said at least one tool container comprising at least one holster, said at least one holster being configured to orient said at least one tool for facilitated access, said at least one tool container further comprising a neck tie holster, said cover portion further comprising at least one accessory container, said at least one accessory container being configured to at least partially store and segregate said at least one accessory, said at least one accessory being operable to at least partially function with said at least one tool, said at least one accessory comprising a pair of scissors, and/or a comb, and/or a spray can, and/or a rag, and/or a razor, and/or a curling iron, and/or talcum powder, and/or business cards.
